(19) United States
(12) Patent Application Publication
(10) Pub. No.: US 2009/0070798 A1
(43) Pub. Date: Mar. 12, 2009

(54) System and Method for Detecting Viewer Attention to Media Delivery Devices

(76) Inventors: Hans C. Lee, Carmel, CA (US); Michael J. Lee, Carmel, CA (US); Tim Hong, San Diego, CA (US)

Correspondence Address: COURTNEY STANIFORD & GREGORY LLP, P.O. BOX 9686, SAN JOSE, CA, 95157, US

(21) Appl. No.: 12/206,700

(22) Filed: Sep. 8, 2008

Related U.S. Application Data
(63) Continuation-in-part of application No. 11/681,265, filed on Mar. 2, 2007.
Application No. 11/681,265 is a continuation-in-part of application No. 11/804,517, filed on May 17, 2007.
(60) Provisional application No. 60/970,898, filed on Sep. 7, 2007.
(60) Provisional application No. 60/970,900, filed on Sep. 7, 2007.
(60) Provisional application No. 60/970,905, filed on Sep. 7, 2007.
(60) Provisional application No. 60/970,908, filed on Sep. 7, 2007.
(60) Provisional application No. 60/970,913, filed on Sep. 7, 2007.
(60) Provisional application No. 60/970,916, filed on Sep. 7, 2007.

(51) Int. Cl. H04H 60/33

(52) U.S. Cl. 725/10

(57) ABSTRACT

Embodiments of a system to accurately record if viewers are actually watching, listening to, interacting with, or otherwise perceiving a television, computer monitor, or other media delivery device at any given moment are described. A detector circuit is coupled to the media delivery device and configured to receive a signal transmitted from an emitter placed on the body of a user positioned proximate the media delivery device. The detector receives a signal from the emitter when the user positions him or herself in a manner that indicates that the user is watching or otherwise paying attention to the media delivery device. An attention detector processor coupled to the detector circuit and configured to determine whether the user is perceiving content provided by the media deliver device.

### CROSS-REFERENCE TO RELATED APPLICATIONS

This application is a continuation in part application of U.S. patent application Ser. No. 11/681,265, filed Mar. 2, 2007.

This application is a continuation in part application of U.S. patent application Ser. No. 11/804,517, filed May 17, 2007.

This application claims the benefit of U.S. Patent Application No. 60/970,898, filed Sep. 7, 2007.

This application claims the benefit of U.S. Patent Application No. 60/970,900, filed Sep. 7, 2007.

This application claims the benefit of U.S. Patent Application No. 60/970,905, filed Sep. 7, 2007.

This application claims the benefit of U.S. Patent Application No. 60/970,908, filed Sep. 7, 2007.

This application claims the benefit of U.S. Patent Application No. 60/970,913, filed Sep. 7, 2007.

The present application claims the benefit of the U.S. Provisional Application No. 60/970,916 entitled “Methods and Systems for Media Viewer Attention Detection Using Means for Improving Information About Viewer's Preferences, Media Viewing Habits, and Other Factors,” and filed on Sep. 7, 2007.

### FIELD

Embodiments of the invention relate generally to media playback systems, and more specifically, to user awareness detection systems for televisions, computer monitors, and other media display devices.

### BACKGROUND

Display devices, such as televisions, computer monitors, personal digital devices, and the like are the principal means of delivering electronic content. Content providers can deliver virtually any type of visual content through a myriad number of display devices. The most common display means has traditionally been the television, however, the advent of the Internet and other networks has led to an increase in viewing through computers, game device, and other media playback units. Although certain user activity can be tracked and measured with regard to content delivery, such as network sites visited or television shows tuned into, there is no present way of knowing whether a person is actually viewing, reading, or otherwise perceiving what is displayed, when a television or computer monitor is turned on.

A significant disadvantage associated with current media research is the reliance on knowing the number of viewers who are watching a specific piece of media, for example a show or commercial on TV. The issue is that current technologies can only record when a television is on, but are not able to take into account that much of the time that the television or web pages are visible, people are not looking at them, but are instead out of the room or otherwise engaged.

Likewise, with computer systems, it may be possible to determine what content or network sites a user may access, but it is generally not possible to know whether or not the user is actually attending to or perceiving the information on the screen.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates an emitter-receiver based viewer attention detection system, under an embodiment.

FIG. 2 illustrates an emitter-receiver based viewer attention detection system, under an alternative embodiment.

FIG. 3 illustrates a camera-based viewer attention detection system, under an embodiment.

FIG. 4 is a flowchart that illustrates a method of detecting and utilizing detected viewer attention to a media delivery device, under an embodiment.

### DETAILED DESCRIPTION

Embodiments of a system to accurately record if viewers are actually watching, listening to, interacting with, or otherwise perceiving a media deliver device, such as a television, computer monitor, or other display mechanism at any given moment are described. A system is configured to sense when a viewer is actually watching television or another electronic device, and make it possible to know when they can be meaningfully engaged by the media. This knowledge can be used by market research entities to measure what media is being viewed and how actively it is being viewed. This can range from users passively watching the screen, or actively paying attention to the screen, or not even viewing the screen at all. The system includes means to sense if a viewer is oriented towards a TV/Radio/Monitor or other media delivery device. Such a system can overcome the disadvantages associated with present systems that generally have problems predicting accurate models of viewership.

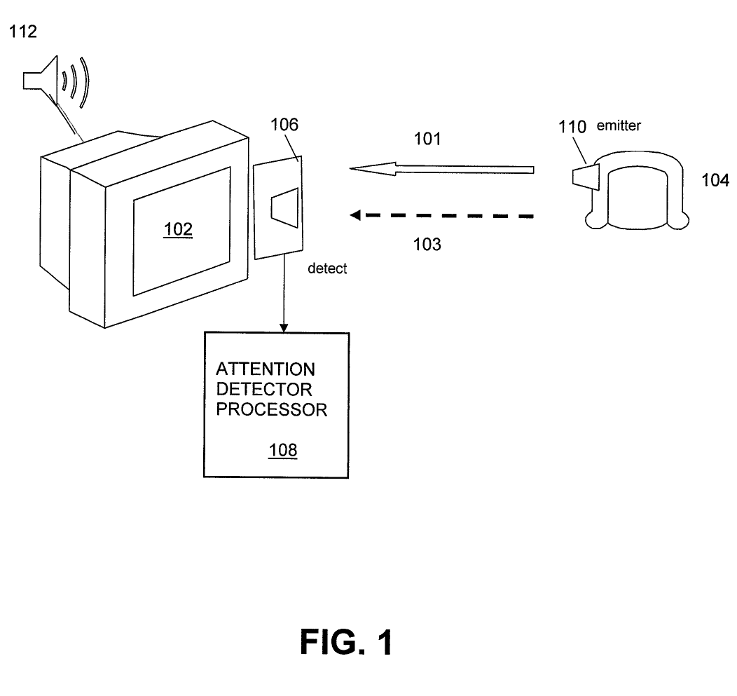

In one embodiment, an emitter is attached to each viewer. The emitter sends out a signal only in the direction the viewer is looking. The system has a receiver for this signal placed in close proximity to the media device, such as a TV, monitor or radio. If the signal is received, then it is assumed that the viewers head is oriented in the right direction to view the monitor. If the user leaves the room or looks the other way, the signal will diminish and disappear. FIG. 1 illustrates an emitter-receiver based viewer detection system, under an embodiment. As shown in FIG. 1, media delivery device (or “monitor”) 102 comprises a display device configured to display any type of visual content, such as streaming video, still pictures, or any other visually perceivable image in analog or digital format. The media delivery device 102 may be embodied in a television, computer monitor, electronic tablet, or any other electronic display device. An audio playback unit, such as speaker 112 may be coupled to or incorporated in the media delivery device to provide audio output for analog or digital sound signals. A user 104 is positioned to perceive the video and/or audio signals from the media delivery device 102. Although the user may be positioned at an appropriate distance to receive the audio and visual signals, it is not always apparent whether or not the user is actually paying attention to the content.

For the embodiment of FIG. 1, the user has an emitter device 110 attached to part of the user's body, such as his or her head 104. The emitter is aligned with the optimum direction of perception through either or both of the eyes and ears of the user. The emitter transmits signals 101 corresponding to the user's line-of-sight 103. A detector circuit 106 included within, or coupled to the monitor 102 is positioned to receive the emitted signals 101. When the user's face 104 is directed to the monitor 102, as indicated by the line-of-sight 103, the detector will receive the emitted signals 101 at or near full strength. Depending upon implementation, a range of signal strengths may be defined in which a received signal indicates that the user is looking at the monitor. The detected signals received by detector 106 are processed in an attention detector processor 108. In one embodiment, the emitter 110 may be implemented as a headset, headband, eyeglass lens system, or any similar system that is aligned to the user's eyes and sights along the user's line of sight when the user is looking straight ahead.

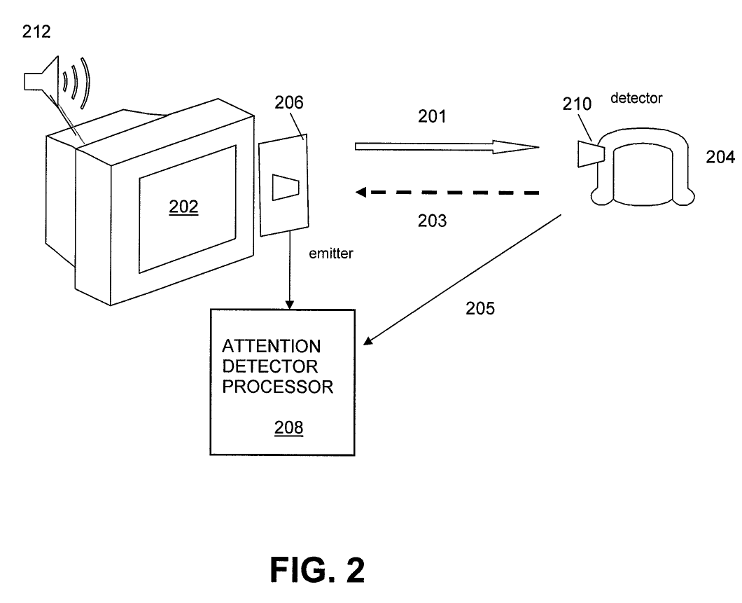

In an alternative embodiment, the emitter may be placed on the media device, with the receiver placed on the user that measures if the signal is visible to the viewer. The user-based receiver can then transmit this information back to a base station either through wired or wireless means. FIG. 2 illustrates an emitter-receiver based viewer detection system, under this alternative embodiment. As shown in FIG. 2, monitor 202 and any associated audio playback component 212 are coupled to an emitter component 206. A user 204 is positioned to perceive the video and/or audio signals from the media delivery device 202. For the embodiment of FIG. 2, the user has a detector device 210 attached to part of the user's body, such as his or her head 204. The emitter 206 is aligned with the optimum direction of perception through either or both of the eyes and ears of the user. The emitter transmits signals 201 in a direction corresponding to an optimum line-of-sight for viewing of the monitor. If the user 204 is in this optimum ling-of-sight 203 position, the detector 210 attached to the user will receive the emitted signals 201 at or near full strength. Depending upon implementation, a range of signal strengths may be defined in which a received signal indicates that the user is looking at the monitor. The detected signals received by detector 210 are transmitted back to an attention detector processor 208. In one embodiment, the detector 210 may be implemented as a headset, headband, eyeglass lens system, or any similar system that is aligned to the user's eyes and sights along the user's line of sight when the user is looking straight ahead.

For the embodiments of FIGS. 1 and 2, the emitter can be an infrared emitter/detector. In an alternative embodiment, the emitter is an ultrasound emitter/detector. In a further alternative embodiment, the emitter and detector utilize laser technology. In yet a further alternative embodiment, a flickering light at a predetermined frequency is utilized. Other comparable emitters and sensors, known to those of ordinary skill in the art can also be used. In addition, combinations of any of these methods can also work.

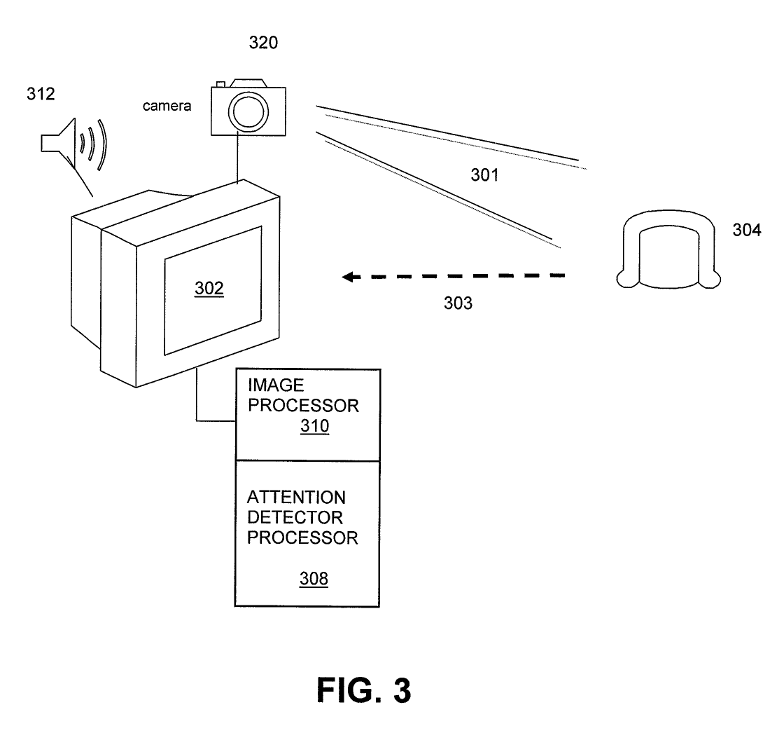

The embodiments of FIGS. 1 and 2 require an emitter/detector system that is distributed between the user and the media delivery device. In an alternative embodiment, detection of the user's orientation with respect to the media delivery device is accomplished by imaging the user's orientation in front of the monitor. For this embodiment, a camera is placed in close proximity to the media device, and a processing unit detects if a user is properly positioned in front of the monitor to indicate whether the user is perceiving the content provided by the monitor. FIG. 3 illustrates a camera-based viewer attention detection system, under an embodiment. A camera incorporated in, or coupled to the monitor 302 is oriented to image a field of view 301 in front of the monitor. The camera may be a still picture camera, video camera, or any similar image capture device and may be analog or digital-based. The camera 320 can be a single camera, a stereo-pair, or a system of cameras.

The field of view 301 imaged by the camera 320 corresponds to an optimum line-of-sight 303 when a user 304 is viewing the monitor 302 from a head-on or nearly head-on orientation. The camera 320 is configured to detect if there is a person in front of the monitor, and more specifically if the user's face is pointed towards the monitor. The camera images within a specific field of focus and transmits images to an image processor component 310. The image processor component includes functions, such as face recognition software that determines whether user is looking at the monitor screen. In certain implementations, the direction of the user's eyes can be determined to make sure that the user is focusing on the screen, rather than just having their face in the direction of the screen. In one embodiment, the image data from the image processor 310 is passed onto an attention detector processor 308 for further processing.

It should be noted that any of the connections between the components in any of FIGS. 1-3 may be implemented through wired or wireless communication means. Likewise, in certain implementations, a computer-based network may be used to transmit one or more signals or data among the components.

In one embodiment, the user may be outfitted with an accelerometer that is attached to a portion of his or her body, such as the head, face, neck, torso, etc. The orientation of the accelerometer can be detected by the attention detector processor 308 to determine if the user is facing the monitor 302 screen. For this embodiment, the accelerometer circuit is attached to a portion of a user positioned proximate the media delivery device at a distance suitable to perceive the monitor. The accelerometer is configured to provide an indication of the position of the user's head relative to the media delivery device. A detector circuit can be coupled to the monitor to receive a signal transmitted from the accelerometer. An attention detector processor coupled to the detector circuit can be configured to determine whether the user is perceiving content provided by the monitor based on one or more signals from the accelerometer.

In general, the viewer attention detection system according to embodiments can detect if a viewer is oriented directly towards the media delivery device. This provides a relatively reasonable indication that the user is paying attention to the media being delivered, and can also help to indicate instances when the user is not paying attention to the media. This information can be utilized by content providers for various purposes. For example, the percentage of time that a user is actively watching the media delivery device relative to the total time the device is powered on can define an “engagement” metric. Very good or engaging media will typically make people want to watch it and they will be glued to their media delivery devices, while less engaging media, even if it is being transmitted to the viewer, may not be actively watched. This is a key new metric for media analysis.

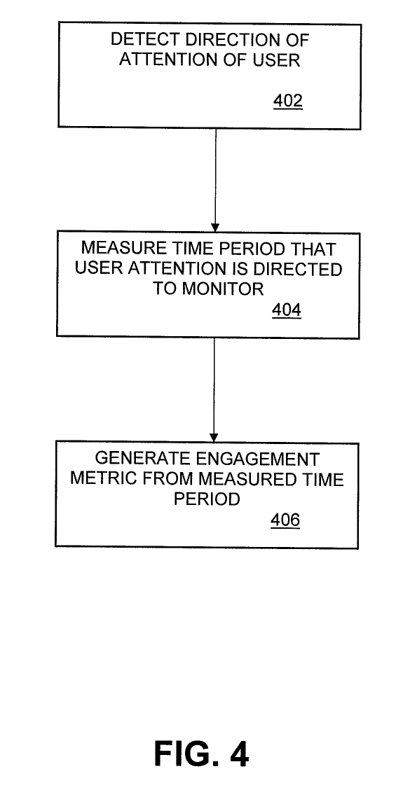

FIG. 4 is a flowchart that illustrates a method of detecting and utilizing detected viewer attention to a media delivery device, under an embodiment. In block 402, the system detects the direction of the attention of the user with respect to the media delivery device. This detection can be performed by the emitter/detector, camera-based, or accelerometer-based systems described above. The time period that the user attention is directed the media delivery device is then measured, block 404. An engagement metric that represents the attention time relative to the total power on time of the device is then generated for the measured time period, block 406.

Another advantage of the attention detection system is aggregating this viewer “engagement” and watching time over very large numbers of participants to create models of viewership for given media types. This information can then be used as a baseline to identify how engaging each type of media is relative to other competitive sources. For example, knowing that a piece of media engages viewers for 60% of the time with them actively watching/listening to the media is an important measure. However, the key information is, given its media type, what is the relative engagement to its competition where the competition average provides a benchmark. If the media is, for example a TV program for a round of golf, and the average time for viewers watch golf is usually 30%, then a 60% engagement measure in this case would be good. On the other hand, if the content was a thriller and the average time watching thrillers is 90+%, then a 60% measure would indicate that the show was not particularly engaging.

This information can then be used to rate show viewership very accurately and provide a measure of the overall engagement by viewers. In one embodiment, the attention detection processing system can be deployed in viewer's homes as part of the usual delivery devices, such as the television. This would allow a great many number of users' responses to be simultaneously measured and aggregated. Such a system can be used by television rating services to provide a more accurate measure of actual user interest, rather than just television tuning measurements.

Aspects of the embodiments described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments is not intended to be exhaustive or to limit the embodiments to the precise form or instructions disclosed. While specific embodiments of, and examples for, the disclosed system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the online loan application system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the system may be presented in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A system comprising:
a media delivery device;
a detector circuit coupled to the media delivery device and configured to receive a signal transmitted from an emitter placed on the body of a user positioned proximate the media delivery device; and
an attention detector processor coupled to the detector circuit and configured to determine whether the user is perceiving content provided by the media deliver device.

2. The system of claim 1 wherein the emitter and detector components utilize a transmission medium selected from the group consisting of: infrared transmission, ultrasound transmission, laser technology, and flickering light at a predetermined frequency.

3. The system of claim 2 wherein the media delivery device is one of a television or a computer monitor.

4. The system of claim 1 wherein the emitter is placed in a head gear positioned on the head of the user and positioned to transmit the signal in a direction corresponding to the line-of-sight of the user, and wherein when the user positions him or herself in a manner that indicates that the user is watching or otherwise paying attention to the media delivery device the detector receives the signal from the emitter.

5. A system comprising:
a media delivery device;
an emitter circuit coupled to the media delivery device and configured to transmit a signal to be received by a detector placed on the body of a user positioned proximate the media delivery device, wherein the detector is configured to transmit an indicator in the event the detector receives the signal; and
an attention detector processor coupled to the emitter circuit and configured to receive the indicator from the detector when the signal from the emitter is received by the detector, in order to determine whether the user is perceiving content provided by the media deliver device.

6. The system of claim 5 wherein the emitter and detector components utilize a transmission medium selected from the group consisting of: infrared transmission, ultrasound transmission, laser technology, and flickering light at a predetermined frequency.

7. The system of claim 6 wherein the media delivery device is one of a television or a computer monitor.

8. The system of claim 5 wherein the emitter is placed in a head gear positioned on the head of the user and positioned to transmit the signal in a direction corresponding to the line-of-sight of the user, and wherein when the user positions him or herself in a manner that indicates that the user is watching or otherwise paying attention to the media delivery device the detector receives the signal from the emitter.

9. A system comprising:
a media delivery device;
a camera coupled to the media delivery device and configured to image an area corresponding to a viewing area in front of the media delivery device;
an image processor coupled to the camera and configured to recognize the presence of a user's face within the viewing area; and
an attention detector processor coupled to the image processor and configured to determine whether the user is perceiving content provided by the media deliver device.

10. The system of claim 1 wherein the camera is one of a still image camera or a video camera.

11. The system of claim 10 wherein the media delivery device is one of a television or a computer monitor.

12. A system comprising:
a media delivery device;
an accelerometer circuit attached to a portion of a user positioned proximate the media delivery device at a distance suitable to perceive the media delivery device, the accelerometer configured to provide an indication of the position of the user's head relative to the media delivery device;
a detector circuit coupled to the media delivery device and configured to receive a signal transmitted from the accelerometer; and
an attention detector processor coupled to the detector circuit and configured to determine whether the user is perceiving content provided by the media delivery device based on one or more signals from the accelerometer.

13. The system of claim 1 wherein the portion of the user is selected from the group consisting of the user's head, face, neck, and torso.

14. The system of claim 13 wherein the media delivery device is one of a television or a computer monitor.
